(19) United States
(12) Patent Application Publication
(10) Pub. No.: US 2003/0065408 A1
(43) Pub. Date: Apr. 3, 2003

(54) Method of product specification for a processing chemical

(76) Inventors: Augusto Rodolfo Quinones, Amstelveen (NL); Jacobus Johannes Leonardus Heinerman, Abcoude (NL)

Correspondence Address: LOUIS A. MORRIS, AKZO NOBEL INC., 7 LIVINGSTONE AVENUE, DOBBS FERRY, NY, 10522-3408, US

(21) Appl. No.: 10/146,695

(22) Filed: May 15, 2002

(30) Foreign Application Priority Data
May 15, 2001 (EP) 01201801.6

(51) Int. Cl. G05B 13/02

(52) U.S. Cl. 700/28

(57) ABSTRACT

A method of product specification for multi-variable processing chemicals to be used in a process carried out in a production unit under given process conditions, the method involving the use of a central data processing system comprising input means and a memory for storing a computational model for prediction of the performance of a specific processing chemical, the method comprising the following steps:

a) a user contacts the central data processing system via a communication network;

b) the central data processing system provides a user interface allowing data entry;

c) input data including data concerning the production unit and data concerning process conditions is fed into the central processing system via the user interface;

d) on the basis of the computational model and the input data, the central data processing system generates, via an optimization routine, one or more product specifications of one or more suitable processing chemicals;

e) the central data processing system returns one or more product specifications to the user.

The input data includes data concerning the required composition of a multi-component process yield.

### CROSS REFERENCE TO RELATED APPLICATION

This application claims priority from European patent application EP01201801.6, filed on May 15, 2001.

### BACKGROUND OF THE INVENTION

1. Field of the Invention

The invention relates to a method and a system for product specification for multi-variable processing chemicals to be used in a process carried out in a production unit, such as a plant or a reactor, under given process conditions.

2. Discussion of the Prior Art

Multi-variable processing chemicals, or performance chemicals, have variable properties or parameters which can be adjusted to optimize their performance. Such properties may for instance be physical parameters, such as specific surface area, pore volume, particle size distribution, etc., or chemical composition. Typical processing chemicals or performance chemicals include polymerization initiators, catalysts, e.g., catalysts for oil cracking or dehydrogenation, etc.

The performance of processing or performance chemicals is generally dependent on process conditions such as temperature, pressure, or the presence of other chemically co-reactive compounds. Due to its dependency on exterior and interior parameters, which are often interdependent, the performance in many cases is hard to predict. Selecting the optimum processing chemical requires thorough knowledge of the product in question on the one hand, and of the processing conditions, and the reactor or equipment to be used, on the other. This requires a degree of chemical engineering that generally does not allow merely selecting a product from a product database or catalogue.

An example is the purchase of suitable catalysts for oil refining. Such catalysts are used, for example, for the catalytic cracking of crude oil into lighter fractions, such as gasoline, LPG, diesel oil, or for hydroprocessing, to modify product properties for a desired fuel requirement like sulfur content or cetane number. There are several types of catalysts, each supporting different reactions. The two largest oil refining applications are fluid catalytic cracking (FCC) catalysts, used for upgrading heavy molecules into useful transportation fuels, and hydroprocessing catalysts (HPC), which are also used for modifying refinery products, e.g., by lowering the sulfur in diesel fuels. FCC catalysts generally comprise a catalytically active component (generally a molecular sieve material such as a zeolite) and matrix/binder material. The matrix material may be catalytically active or not. Some matrix materials act both as a matrix and as a binder material. In other cases, additional binder material has to be added to obtain the required physical and mechanical strength. Optionally metals or metal oxides, such as rare earth metals, are incorporated into the molecular sieve material or the matrix material or both to influence the catalytic and physical properties of the catalyst. The composition of the catalysts determines which reaction is catalyzed. For instance, greater yields of gasoline are generally obtained if the rare earth content in the catalyst is increased. However, the final yield of the cracking process depends not only on the type of catalyst used, but also on the composition of the crude oil to be refined, the plant design, process variables, unit constraints, etc.

Up to now, oil cracking catalysts have generally been chosen after one or several consultations with the supplier. On the basis of data concerning the plant lay-out and limits, and the required composition of the refinery end products, the supplier determines which catalyst will be the most useful for the customer in question. Empirical knowledge of the specific characteristics of the plant in question, obtained after experiences with previously ordered catalysts, is not fully taken into account to optimize customization of the ordered catalysts, since usually the end user lacks details of the formulation of the catalyst. In the few cases where some specific catalyst formulations details are given, the catalyst supplier will give the information under comprehensive secrecy agreements.

Market prices of the various refinery products generally fluctuate. In consequence, it is often desirable to change the composition of the refinery yield. A greater demand for gasoline combined with a reduced demand for, for instance, diesel may result in the refinery changing its output by maximizing gasoline production at the cost of diesel yield. In the context of FCC, this could be done by using a different combination of catalyst composition and process variables. However, in view of the cost and the time it currently takes to implement the use of a new catalyst, the usual response generally is to vary only the process variables.

Similar problems exist in other chemical processes using multi-variable user-specific process chemicals, such as the polymer industry, the paper making industry, water treatment, etc.

The object of the present invention is to provide a method and a system for the product specification of multi-variable processing or performance chemicals making optimized use of a supplier's know-how to customize the products to the purchaser's specific needs, for instance in reaction to changes in market demand.

A second object of the invention is to use the possibilities offered by communication technology for optimizing client-specific customization of processing chemicals, for instance for the purpose of an on-line ordering system.

### SUMMARY OF THE INVENTION

Accordingly, in one embodiment, the present invention is a method of product specification for multi-variable processing chemicals to be used in a process carried out in a production unit under given process conditions. The method involves the use of a central data processing system comprising input means and a memory for storing a computational model for prediction of the performance of a specific processing chemical, the method comprising the following steps:

a) a user contacts the central data processing system via a communication network;

b) the central data processing system provides a user interface allowing data entry;

c) input data including data concerning the production unit and data concerning process conditions is fed into the central processing system via the user interface;

d) on the basis of the computational model and the input data, the central data processing system generates, via an optimization routine, one or more product specifications of one or more suitable processing chemicals;

e) the central data processing system returns one or more product specifications to the user.

In a second embodiment, the invention comprises a server system with a central data processing unit comprising:

a memory storing a user interface for data entry via a client system;

means for communication with a client system;

a memory storing a computational product model;

a memory storing a program comprising an optimization routine for specifying one or more processing chemicals based on the computational model and the input data;

at least one processing unit for running the program using the computational product model and the input data to specify a processing chemical.

In a third embodiment, the invention comprises a computer program comprising an optimization routine for specifying one or more processing chemicals based on a computational product model and input data, optionally including data concerning the required composition of a multi-component process yield.

Other embodiments of the invention comprise preferred and more detailed versions of the above three embodiments.

### BRIEF DESCRIPTION OF THE DRAWINGS

FIG. 1 is a block diagram showing client/server interconnection in a system according to the invention;

FIG. 2 is a block diagram of a client terminal environment in a system according to the present invention.

### DETAILED DESCRIPTION OF THE INVENTION

Ordering products via telecommunication networks has become increasingly important in modern economic practice. The Internet in particular enjoys increasing popularity as a platform for so-called electronic commerce or e-commerce.

The Internet is a worldwide network of computers interconnected through communication links. The interconnected computers exchange information via various platforms, such as electronic mail and the World Wide Web (“WWW”). Information exchange on the Internet, as well as on many other non-public networks, is based on a protocol called the Transmission Control Protocol/Internet Protocol (TCP/IP).

The World Wide Web allows a server computer, a so-called web server or web site, to send graphical web pages to a remote client computer. The client computer can then display the received web page. Each web site of the WWW is uniquely identifiable by a Uniform Resource Locator (“URL”). The typical URL format is HTTP://WWW.DOMAIN NAME.TLD/DOCUMENT.HTML. “HTTP” stands for Hyper Text Transfer Protocol. “DOMAIN NAME” is the name of a server; “TLD” is the top level domain name, usually “.com” or a country code such as “.nI” or “.de”. “DOCUMENT.HTML” is the name of a document or file on the server which the user is accessing, or it may be omitted to call up a “home page” (a starting point for the web site). To view a specific web page, a client computer system specifies the URL for that web page in a request, such as an HTTP request. The request is forwarded to the web server corresponding to that web site. In reply, the server sends the web page to the client computer. The client computer receiving the web page displays it using a browser. Examples of browsers are Netscape Navigator® of Netscape Communications and Microsoft Explorer® of Microsoft.

Web pages are defined using Hyper Text Markup Language (“HTML”). HTML includes a standard set of tags which define how a web page is to be displayed. On the command of the user, the browser sends a request to the server computer to transfer an HTML document defining the web page to the client computer. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

Due to its interactive nature, the World Wide Web is especially useful for commercial activities, generally referred to as e-commerce. Many web sites have been developed for advertising and selling products to be delivered through conventional distribution channels. With the aid of a server computer a potential purchaser may specify or select items for purchase. On completion of the selection of the items to be purchased, the server computer system prompts the user for information to complete the order. On-line ordering systems are disclosed in U.S. Pat. No. 5,897,622 and U.S. Pat. No. 5,960,411, incorporated herein by reference. An example of an on-line ordering system for chemical products is the web site http://www.basechemicals.com of Akzo Nobel Chemicals BV, Netherlands.

The purchaser-specific order information often contains sensitive information, which is transmitted over the Internet passing through various intermediate computer systems on its way to its final destination. Therefore, it is often desirable to secure such information. To secure sensitive information, various encryption techniques are used when transmitting such information between a client computer system and a server computer system. Another way to secure confidential information is to use an extranet construction, a firewall protected network connected to the Internet with access restricted to accredited users.

Instead of the World Wide Web, other platforms can also be used, such as electronic mail. As an alternative to the Internet, other networks such as local area networks (LANs) and wide area networks (WANs), using other networking protocols and/or hardware, interactive television networks, telephone networks, wireless data transmission systems, two-way cable systems, etc. are also suitable for such use.

Generally, ordering products via a communication network has the drawback that the customer must provide a complete specification of the product he wishes to order. This makes the existing systems less suitable for products which require the supplier's know-how to customize them to the customer's specific needs.

The above-mentioned objects of the present invention are achieved with the method comprising the above described first embodiment for product specification for multi-variable processing chemicals to be used in a process carried out in a production unit under given process conditions

Such a method can be conveniently implemented using computer networks, such as the Internet, an intranet or an extranet. The customer has easy access to the supplier's server system and can make optimum use of the supplier's know-how and engineering facilities. Optionally, step a) can be performed automatically, for instance at regular intervals.

The computational product model can be a formula or a set of formulae for variables relating to the properties to be optimized expressed as a function of variables for input values, and optionally weighing factors or other constants, and/or products of two or more interdependent input variables, etc. The variables relating to the properties to be optimized may also be mutually dependent, in which case one variable is expressed as a function of one or more other variables to be optimized and/or one or more variables for input values.

If so desired, the data processing system may comprise a memory storing a product database. On the basis of the generated product specification, a product can be selected from the product database most closely matching the generated product specification.

In a preferred embodiment of the method according to the invention, the input data includes data concerning the required composition of a multi-component process yield. This is particularly useful in the oil refining industry, where a series of products is produced when cracking the crude oil. By changing the catalyst composition and/or the process conditions, the composition of the process yield can be adjusted by the plant controller if so desired in view of economic considerations.

The input data may also include economic prices for one or more compounds of the process yield, while a processing device is used, e.g., as a user terminal or as a central data processing system, to calculate the economically optimized composition of the process yield, and subsequently to use the optimized composition data for specifying the processing chemical.

Preferably, data on the composition of the product yield obtained using the processing chemicals specified in an earlier session is used for optimizing the computational product model. This way, a self-learning feedback loop is created. This allows the development of a customized product model and improved predictions about the effect of using the process chemicals in the plant of the customer in question.

In most complex multi-variable chemical processes, the effect of changing a processing chemical, such as a catalyst, may have consequences which are difficult to predict precisely for all possible applications. This situation can translate into a certain risk of reduced plant efficiency if the prediction is erroneous. To lower this risk, it is preferred that the computational model for performance prediction of the processing chemical to be specified includes security constraints for one or more variables to limit the predictions to within a safe window of operation. Using the self-learning loop as set out above results in an improved and more reliable computational model, which allows adjustment of the security constraints when the computational product model is adjusted on the basis of the composition of the product yield obtained using the processing chemicals specified in an earlier session.

If, as preferred, the central data processing device combines the specification of the process chemicals with an order form, the purchaser can use the system for easy ordering of the specified product, which can be delivered via conventional delivery channels.

A server system can be used with a data processing unit comprising the above second embodiment. The server can be a minicomputer, a microcomputer, a mainframe computer, a personal computer such as an Apple® computer or a personal computer comprising an Intel® CPU, e.g. Intel® Pentium, or clones thereof or any other appropriate computer. The server computer may comprise any suitable operating system, e.g., Unix®, Windows®, Macintosh® or Linux®.

The means for communication with a client system include a suitable modem with an interface for connection to a communication network and further provisions needed for external data communication, such as a network card, as is readily known to the person skilled in the art.

A further object of the invention is a client system for use in the above-described method. This object is achieved with a client system linked or linkable to a server system via a communication network and comprising means for collecting data on production unit design, process conditions, and, optionally, data concerning the required composition of a multi-component process yield, as well as means for communication with the server system.

The means for collecting the required data can for example comprise the usual input means, such as a keyboards, mouse, etc., for direct input by a user via a suitable user interface.

The client system may comprise a minicomputer, a microcomputer, a mainframe computer, a personal computer such as an Apple® computer or a personal computer comprising an Intel® CPU, e.g. Intel® Pentium, or clones thereof or any other appropriate computer. The server computer may comprise any suitable operating system, e.g., Unix®, Windows®, Macintosh® or Linux®. Access to the network may be provided by an on-line service provider, or the client computer may have direct access to the network.

The invention also involves the computer program of the above third embodiment for implementing wholly or partly the above-described method, and a data carrier carrying such a program. Advantageously, the computer program may allow or require input of economic prices for one or more of the components of the process yield, the program comprising a routine for calculating an economically optimized process yield composition and a routine for using the economically optimized process yield composition for specifying one or more processing chemicals based on the computational product model and input data relating to process conditions and production unit parameters.

The invention will now be described in more detail in connection with embodiments of the invention and with reference to the drawings:

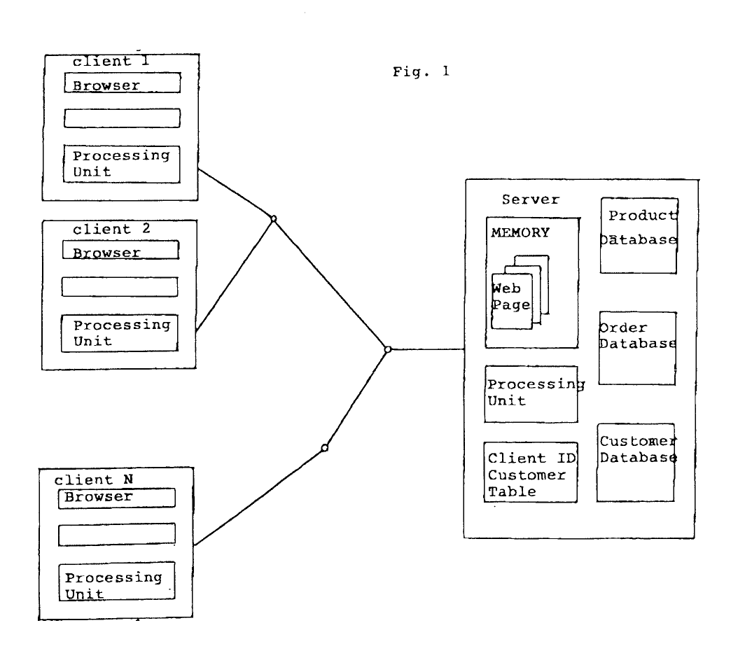

FIG. 1 is a block diagram illustrating a client/server connection in a system according to the present invention. This particular embodiment supports information exchange and ordering over an extranet, using a web-based communication. The system includes a server 1 comprising a memory 3 with various web pages 4, a customer database 5, an order database 6, and a product database 7. A number of client systems 8 are connected to the server 1 via communication links, in this particular embodiment via an extranet. Some or all of the communication links may be either temporary links or permanent links. The communication links can be satellite links, telephone line links, or any link for permitting communication between computers, in any combination. The various communication links may be of different types. Although only a limited number of clients are shown to be connected to the server, a large number of client can be simultaneously connected to the server. The number of clients using the server system can be restricted by limiting accessibility.

Different protocols may be employed for communication between the clients and the server. In this particular embodiment, the TCP/IP protocol is employed for communication between the server and the clients. Some of the clients may themselves be servers maintained by service providers.

The server 1 receives a request, e.g., an HTTP request, to access a web page identified by the corresponding URL and provides the web page to the requesting client system. The customer database 5 contains information on various purchasers such as the name of the customer, billing information, plant information, and information from earlier sessions and orders. The order database 6 contains an entry for each order that has not yet been shipped to the ordering purchaser. The product database 7 contains data on the products that may be ordered.

The client system 8 contains a modem for connecting it to the communication network, and a browser 9. The server and client systems interact by exchanging information via network link 10. The client system 8 further includes usual components such as a processor, input devices such as a keyboard and a mouse, output devices, such as a monitor and a printer, RAM and ROM memories, a hard disk drive, floppy disk drive, tape unit, CD-ROM, etc., serial ports, parallel ports, communication hardware, which may either be internal or external, such as modem cards or network cards, etc.

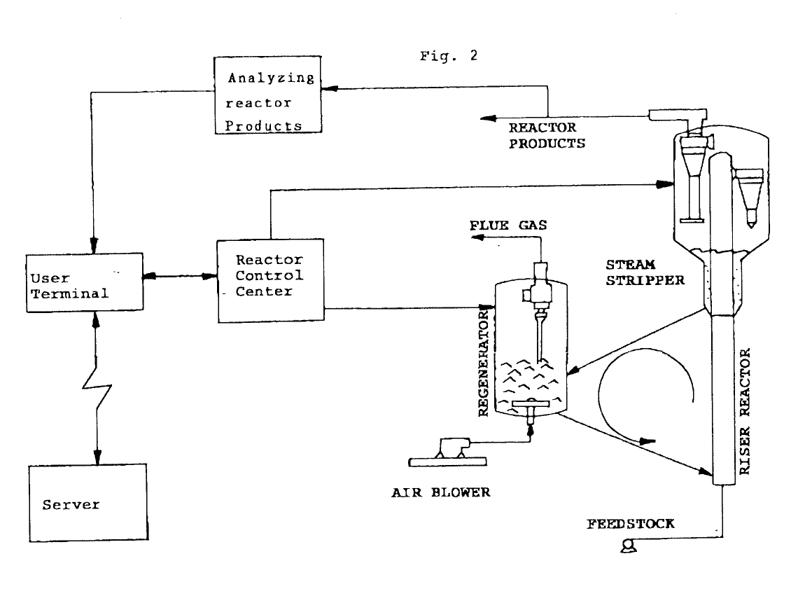

A diagram representation of a client system in a system according to the invention is shown in FIG. 2. The client system includes a user terminal 11 which is connected via a telecommunication network to the remote server system of a supplier of the goods to be ordered. The user terminal, typically a personal computer in an intranet environment, is connected to a reactor control center 12 controlling the process in a plant 13, which in this particular example is an oil refinery. The oil refinery 13 includes a riser reactor 14 where crude oil is cracked into fractions, the reactor products. By distillation techniques, the various reactor products are separated and discharged. During the cracking process, the catalysts are covered with waste product, generally coke. To regenerate the catalysts for reuse, a portion thereof is continuously withdrawn from the riser reactor 14 and transported to a regenerator 15, where the catalysts are treated with hot air from a hot air generator 16. The hot air burns the catalysts clean, after which they are returned to the riser reactor. Since regeneration generally does not recover all catalyst product, part of the catalyst flow is drawn off and replaced by fresh catalysts. Usually, about 0.5-5% of the catalysts is replaced every day.

The yield of reactor products is dependent on various factors. The composition of the crude oil, the type of catalyst, the used matrix or binder material, the presence of metals in the catalysts, the process conditions, such as pressure and temperature, the plant lay-out, all affect the composition of the resulting reactor products.

When considering ordering a new batch of catalyst, the purchaser will contact the server of the supplier via the user terminal and, in this particular example, via the extranet. Via an HTTP request, the purchaser enters identification data, generally a name and a password. After entering the password, a further HTTP request calls for a query template on web page format, allowing the purchaser to provide the necessary plant lay-out data, the process variables, data concerning the crude oil to be refined, and the composition of the required final product. The completed query template is returned to the server. On the basis of the supplied data, the server determines the design of a customized catalyst. Further data, such as address of delivery, billing data, etc. is supplied by the purchaser to the supplier's server in an additional query form. In a relational database, the server construes a parametrized model of the refinery data on the basis of the provided plant lay-out data, the process variables, and the data concerning the crude oil to be refined. On the basis of the parametrized plant model and on the basis of the required composition of the refinery yield, a customized catalyst is determined. Customer related data, including the parametrized model, is stored in the customer database. If the purchaser agrees with the resulting product specification and sales conditions, the order is completed, and the ordered material is shipped via conventional channels.

Due to the complex multi-variable nature of the oil refining process, predicting with 100% accuracy is not possible. Hence the product yields in practice will be different from the yields predicted by the model when customizing the catalyst. When a new supply of catalyst is to be ordered, the purchaser again contacts the server of the supplier via the communication network. The server sends a web page to the purchaser including a query template which has been partially completed by the server itself on the basis of the data in the customer database. In the query template, the purchaser can provide the server with data concerning the actual composition of the refinery yields using the last supplied catalyst. Upon receipt of this data, the server will amend the parametrized model for the purchaser in question. In a next step, the server determines which catalyst would give optimum results based on the amended parametrized model. Subsequently, the purchaser is offered the newly designed catalyst and a new order may follow.

With every subsequent order, the server adjusts the parametrized model of the customer's refinery. This way, the model becomes more and more accurate and learns to make better predictions as to the effect of catalysts.

In the query template, or in a subsequent or preceding one, the customer is offered the opportunity to amend the other customer related data, such as data concerning the plant lay-out. The customer may also specify a different composition of the desired output. If for instance the market price for gasoline has risen, the customer may want to increase the gasoline content in the refinery yield. If the customer specifies a new profile of a desired final composition via the corresponding query template, the server will specify a new catalyst on the basis of the parametrized plant model and on the basis of the desired composition of the final product, in the same way as set out above.

### EXAMPLE 1

Typically, in catalytic cracking processes vacuum gas oil and residue are used as raw material that is converted to lighter products such as gasoline and light cycle oil (LCO). In this example, a unit having a size of 10,000 tons at a cost of $15/ton is used. The output of gasoline and LCO can be adjusted by changing the properties of a performance chemical named FCC Catalyst by changing the Micropore Surface Area (commonly called Zeolite Surface Area or ZSA) and the Mesopore Surface Area (commonly known as Matrix Surface Area or MSA). The ZSA can vary between 250 and 150 m²/g, whereas the MSA can vary between 50 and 200 m²/g. Due to the physical properties limitations that affect the retention of the FCC Catalyst in this example, the sum of ZSA+MSA is limited to a total value of 350 m²/g.

A central data processing system is programmed to use a computational model to predict of the performance of FCC Catalysts. In the computational model, the amount of gasoline G (in tons) is expressed as a function of ZSA and MSA in Formula 1:

G=100*{45*{1−Exp [−0.00005*(ZSA)²−0.003*(MSA)}+0.02* (ZSA+MSA)}

The value of Exp is specific for a certain process plant. In this example, a value of Exp=−0.00005 is used.

In the computational model, the output of LCO (in tons) is expressed as a function of ZSA and MSA in Formula 2, where the value for Exp is the same as the value for Exp in formula 1:

LCO=100*{40*{1−Exp[−0.00002*(ZSA)−0.000013*(MSA)²]}+0.015* (ZSA+MSA)}

In this example, the price of gasoline is 210 $/ton while the price of LCO is 140 $/ton. All other products have a price equal to 70 $/ton. Given these prices, it was calculated by a Customer that a total output of G=4,905 tons of gasoline and LCO=1,378 kg of LCO for a total value of 1.48 million $/day and a cost of 0.7 million $/day would give optimized economic profitability.

To specify a suitable FCC catalyst which would realize the calculated most profitable yield, the Customer contacts the central data processing system via an extranet communication network. After he has provided a password, the central data processing system selects a computational model suitable for the Customer and presents a suitable template for data input, allowing the Customer to specify the desired composition of the process yield. The Customer also specifies the raw material to be used and certain variable process conditions. Based on the computational model and the given input data, the central data processing system calculates which ZSA and MSA values give the desired process yield. On the basis of formulae 1 and 2, the required output values G and LCO are acquired with a ZSA value equal to 215.4 m²/g and an MSA value equal to 134 m²/g. Subsequently, the central data processing system selects a suitable FCC catalyst most closely matching the desired ZSA and MSA properties.

Prices of gasoline, LCO, and other output components typically fluctuate over time. If in this example the price of gasoline decreases to 175 $/ton while the price of LCO increases to 245 $/ton, the total value of the process would decrease to 1.46 million $/day if the same catalyst were used.

However, economic profitability can be maximized again by calculating the preferred output values of G and LCO based on the new economic prices. In this case, it was calculated that maximizing profitability required a process yield with G=4,398 tons of gasoline and LCO=2,154 tons of LCO for a total value of 1.54 million $/day. In the formulae of the computational model, this is achieved with an FCC catalyst having a ZSA=150 m²/g and an MSA=200 m²/g.

The actual output content of gasoline and LCO will differ to some extent from the values predicted by calculation. These differences will vary per plant. A Customer A may provide data showing that the exponent Exp of ZSA for their gasoline yield, as used in formula 1 given above, should not be −0.00005 but −0.00006. On the other hand, a Customer B may agree with the dependence on ZSA as expressed in formula 1, but disagree about the dependence on ZSA and MSA for LCO, as expressed in formula 2. Customer B may consider the values of −0.000018 and −0.000015 to be the proper values.

By creating parameters associated with the original data set which are uniquely associated with Customer A and Customer B, the computational model of formulae 1 and 2 can be “customized,” thus improving the usefulness of the model for each of them. In this example, the customized versions of formula 1 and 2 are:

G=100*{45*f1*{1−Exp[−0.00005*f2*(ZSA)²−0.003*f3* (MSA)]}+0.02*f4*(ZSA+MSA)}

LCO=100*{40*f5*{1−Exp[−0.00002*f6*(ZSA)−0.000013*f7* (MSA)²]}+0.015*f8*(ZSA+MSA)}

wherein f1, f2, f3, f4, f5, f6, f7, and f8 are the parameters used for customization. For Customer A, f1, f2, f3, f4, f5, f6, f7, and f8 are equal to 1, but f2=1.2. For Customer B, f1, f2, f3, f4, f5, and f8 are 1, but f6=1.15 and f7=0.9.

In the context of e-business, such customization can be done very rapidly, thus making a more rapid and meaningful process optimization possible.

The following Table 1 shows how customized catalyst optimizations maximize profitability. In row 1, the first calculation example set out above is given. In row 2, the result is given when prices change without the catalyst being changed. In row 3, the results are given when, with the same changes in prices, a new FCC Catalyst is selected for again maximizing economic profitability, also as set out above. Row 4 gives the results for Customer A using a customized model for calculation, based on the old prices, whereas row 5 gives these results based on the changed prices. Similarly, row 6 of Table 1 gives the results for Customer A using a customized model for calculation, based on the old prices, whereas row 7 gives these results based on the changed prices. Example 8 shows a different case where due to the specific unit conditions, the ZSA+MSA constraints could be relaxed to 375 M²/g.

TABLE 1

| | | | | | | | | Total |
|---|---|---|---|---|---|---|---|---|
| | | | | | | | | Output |
| | Gasoline | LCO | Rest | ZSA | MSA | Gasoline | LCO | million |
| | $/ton | $/ton | $/ton | m2/g | m2/g | tons | tons | $/day |
| 1 | 210 | 140 | 70 | 215 | 135 | 4,905 | 1,378 | 1.48 |
| 2 | 175 | 245 | 70 | 215 | 135 | 4,905 | 1,378 | 1.46 |
| 3 | 175 | 245 | 70 | 150 | 200 | 4,398 | 2,154 | 1.54 |
| 4 | 210 | 140 | 70 | 196 | 158 | 4,915 | 1,602 | 1.50 |
| 5 | 175 | 245 | 70 | 150 | 200 | 4,560 | 2,154 | 1.56 |
| 6 | 210 | 140 | 70 | 192 | 159 | 4,753 | 1,958 | 1.5 |
| 7 | 175 | 245 | 70 | 150 | 200 | 4,398 | 2,582 | 1.61 |
| 8 | 175 | 245 | 70 | 125 | 225 | 4,151 | 2,920 | 1.65 |

### EXAMPLE 2

In this example, a customer is using a catalyst that can be defined in terms of zeolite, active matrix, binder, rare earth on zeolite, metal trap type and content, and Z- additive. The following table shows the types of variables and the range of values for which it is possible to vary each of them.

TABLE 2

| | Minimum | Maximum | Customer A |
|---|---|---|---|
| Zeolite Content | 10% | 50% | 35% |
| Rare earth on | 0.1% | 10% | 2.3% |
| Catalyst | | | |
| Active Matrix | 0% | 40% | 7% |
| Binder % | 18% | 30% | 26% |
| Metal trap | 0% | 10% | 2% |
| Z-additive | 0% | 25% | 5% |

In the context of this invention, it would not be prudent to allow a customization where the whole catalyst formulation window is considered viable. One of the reasons is that the predictive value of the models will diminish as we deviate from the current operation (for which more data is available). To manage this risk, it is better to restrict the values over which the parameters will be allowed to float in the optimization, as shown for example in Table 3.

TABLE 3

| | Customer A | Minimum allowed | Maximum allowed |
|---|---|---|---|
| Zeolite Content | 35% | 30% | 40% |
| Rare earth on | 2.3% | 1.8% | 2.8% |
| Catalyst | | | |
| Active Matrix | 7% | 3% | 12% |
| Binder % | 26% | 22% | 30% |
| Metal trap | 2% | 0% | 5% |
| Z-additive | 5% | 2% | 8% |

Furthermore, another useful approach is to take a relative amount of some or all the components, as sometimes the actual formulation is not disclosed.

TABLE 4

| | Customer A | Minimum allowed | Maximum allowed |
|---|---|---|---|
| Zeolite Content | Base | −10% | 10% |
| Rare earth on | 2.3% | 1.8% | 2.8% |
| Catalyst | | | |
| Active Matrix | Base | −50% | +50% |
| Binder % | Base | −25% | +25% |
| Metal trap | Base | −50% | 50% |
| Z-additive | Base | −50% | 50% |

In the self-learning loop scenario, after several iterations have been used to customize the model for the customer in question, the window of operation can be opened stepwise to explore further in the formulation window, as shown for example in Table 5.

TABLE 5

| | Customer A | Minimum allowed | Maximum allowed |
|---|---|---|---|
| Zeolite Content | Base | −20% | 10% |
| Rare earth on | 2.3% | 1.8% | 3.2% |
| Catalyst | | | |
| Active Matrix | Base | −50% | +150% |
| Binder % | Base | −25% | +25% |
| Metal trap | Base | −50% | 100% |
| Z-additive | Base | −100% | 100% |

1. A method of product specification for multi-variable processing chemicals to be used in a process carried out in a production unit under given process conditions, the method involving the use of a central data processing system comprising input means and a memory for storing a computational model for prediction of the performance of a specific processing chemical, the method comprising the following steps:
a) a user contacts the central data processing system via a communication network;
b) the central data processing system provides a user interface allowing data entry;
c) input data including data concerning the production unit and data concerning process conditions is fed into the central processing system via the user interface;
d) on the basis of the computational model and the input data, the central data processing system generates, via an optimization routine, one or more product specifications of one or more suitable processing chemicals;
e) the central data processing system returns one or more product specifications to the user.

2. The method of claim 1 wherein the input data includes data concerning the required composition of a multi-component process yield.

3. The method of claim 2 wherein the input data includes economic prices for one or more compounds of the process yield and a processing device is used, either as a user terminal or as a central data processing system, to calculate the economically optimized composition of the process yield, and subsequently to use the optimized composition data for specifying the required processing chemical.

4. The method of claim 1 wherein data on the composition of the product yield obtained using the processing chemicals specified in an earlier session is used for optimizing the computational product model.

5. The method of claim 1 wherein the computational model for performance prediction of the processing chemical to be specified includes security constraints for one or more variables to allow optimization only within a safe window of operation.

6. The method of claim 5 wherein with an adjustment of the computational model, the security constraints are also adjusted.

7. The method of claim 1 wherein the central data processing device combines the specification of the process chemicals with an order form.

8. The method of claim 1 wherein the communication network is a computer network, such as the Internet, an extranet or a private network.

9. The method of claim 1 wherein the processing chemicals to be specified are catalysts for use in oil refining, such as FCC or HPC catalysts.

10. A server system with a central data processing unit comprising:
a memory storing a user interface for data entry via a client system;
means for communication with a client system;
a memory storing a computational product model;
a memory storing a program comprising an optimization routine for specifying one or more processing chemicals based on the computational model and the input data;
at least one processing unit for running the program using the computational product model and the input data to specify a processing chemical.

11. A client system linked or linkable via a communication network to a server system according to claim 10, comprising means for collecting data on production unit design, process conditions, and, optionally, data concerning the required composition of a multi-component process yield, as well as means for communication with the server system.

12. A computer program comprising an optimization routine for specifying one or more processing chemicals based on a computational product model and input data, optionally including data concerning the required composition of a multi-component process yield.

13. The computer program of claim 12 wherein the input data includes economic prices for one or more of the components of the process yield, the program comprising a routine for calculating an economically optimized process yield composition and a routine for using the economically optimized process yield composition for specifying one or more processing chemicals based on the computational product model and the input data relating to process conditions and production unit parameters.

14. A data carrier carrying a the computer program of claim 12.
